(19) United States
(12) Patent Application Publication
(10) Pub. No.: US 2004/0059827 A1
(43) Pub. Date: Mar. 25, 2004

(54) System for controlling network flow by monitoring download bandwidth

(75) Inventors: Chia-Chi Chiang, Taipei (TW); Yu-Sheng Lin, Taipei (TW); Wen-Che Wu, Ilan (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/377,780

(22) Filed: Mar. 4, 2003

(30) Foreign Application Priority Data
Sep. 20, 2002 (TW) 91121672

(51) Int. Cl. G06F 15/16

(52) U.S. Cl. 709/235; 709/227

(57) ABSTRACT

The present invention relates to a system for controlling network traffic by monitoring download bandwidth. At the enterprise network side, for the network application with asymmetric bandwidth, such as HTTP, FTP or the like, the behavior of the user in the enterprise to establish connections with the external servers is controlled by gathering and analyzing the download bandwidth between the servers and the network application programs, so as to achieve a reasonable use of the bandwidth. The denied connections of the network application programs are queued, and related queuing information is given to the user. When the connection is allowed to be established, the network application program is automatically connected to the desired server.

### BACKGROUND OF THE INVENTION

1. Field of the Invention

The present invention relates to a network flow control system, and more particularly to a system for controlling network flow by monitoring download bandwidth.

2. Description of Related Art

An enterprise usually constructs an internal Ethernet network, and connects internal network to Internet via one or more Internet Service Provider (ISPs), as shown in FIG. 1 .Under this architecture, an bandwidth management necessarily performs on the link between the customer side 11 and the service provider side 12 to handle insufficient bandwidth condition.

In general case, users in internal network accessing the external servers 121 are more than users in external network accessing the internal servers. Furthermore, the network applications, such as HTTP or FTP, used by users mostly have asymmetric bandwidth property. (In such applications, the downloading data packets consume more bandwidth than the uploading control packets). When above two conditions stand, and too many users access external server, the download bandwidth will exhaust before the exhaustion of the upload bandwidth. This causes two problems:

(1) The download bandwidth exhaustion affects the connection speed both on the important accessing (placing an order) and unimportant accessing (browsing news). In this case, the unimportant accessing wastes the insufficient download bandwidth.

(2) Even all the accessing is important, the slow connection speed leads to disconnection (due to time-out), and the users need to repeatedly re-connection also waste the insufficient download bandwidth.

Currently, two kinds of bandwidth management methods are provided: packet scheduling method and TCP bandwidth management method. Packet scheduling method, as shown in FIG. 2, classifies packets into different queues 21, and performs a specific algorithm to determine which queue can send packets into the link. This method can classify important network packets into a higher priority queue which can use more bandwidth than lower priority queue to resolve the first problem. However, this method has two disadvantages. First, the packet scheduling method must be performed in the service provider side 12 to control the download bandwidth. The enterprise can't easily modify the configuration of this method and can't use this method without service provider support. Second, when the download bandwidth is insufficient, the packet scheduling method can't stop the request packets transmitted from the enterprise side. The request packets still can cause too many equally important packets queued in the service provider side, resulting in slower connection speed or disconnection. Obliviously, the packet scheduling method still can't resolve second problem.

TCP method changes traditional TCP flow control parameters to control the download bandwidth. FIG. 3 is a schematic view of a normal TCP connection. Client and Server initially determine the maximum segment size (mss); all packets' size can't be larger than mss. Each side keeps window size (win) and acknowledge information to determine whether send out additional packets into network. TCP method modifies mss and win values or delays ACK packets to control bandwidth. TCP method can control TCP connection bandwidth in the customer side. However, some application, such as video streaming, transfers data by UDP packets, but TCP method can't control the bandwidth used by those applications. TCP method complicatedly overwriting mss or win value in all packets is hard to implement.

Moreover, the current network application usually uses multiple TCP and even UDP connections for transferring data, but the aforementioned two methods only focus on a single TCP connection bandwidth control. Therefore, the conventional skills are inefficient and an improvement is desired.

### SUMMARY OF THE INVENTION

Accordingly, the present invention provides a system for controlling network flow by continuously monitoring the download bandwidth utilization. This system dynamically determines whether permitting a connection can be established between an internal user and an external server based on the monitored download bandwidth information.

The network flow controlling system also provides a mechanism that redirects the unpermitted connections to a queue, and provides the queuing information, and finally permits the connection to be established until the bandwidth is available.

To achieve above object, the network flow controlling system includes: a service provider side having at least one server for providing network services; a customer side having users capable of establishing a new session to the server via a link; and an application gateway arranged in the customer side for performing bandwidth management on a link between the customer side and the service provider side. The application gateway includes: a connection-wait queuing unit with a main queue; and a connection admission control unit for managing the session establishments between the internal users and external servers.

The various objects and advantages of the present invention will be more readily understood from the following detailed description when read in conjunction with the appended drawing.

### BRIEF DESCRIPTION OF THE DRAWINGS

FIG. 1 shows architecture of a conventional network accessing service;

FIG. 2 is a schematic view showing the packet scheduling method;

FIG. 3 is a schematic view showing the packet exchange in a TCP connection;

FIG. 4 shows the bandwidth controlling system in accordance with the present invention;

FIG. 5 is a structure view of an application gateway in accordance with the present invention;

FIG. 6 is a schematic view showing the establishment of a HTTP session;

FIG. 7 is a schematic view showing the establishment of a FTP session;

FIG. 8 shows the flow chart for transmitting packets in accordance with the present invention; and

FIG. 9 is a structure view of another application gateway in accordance with the present invention.

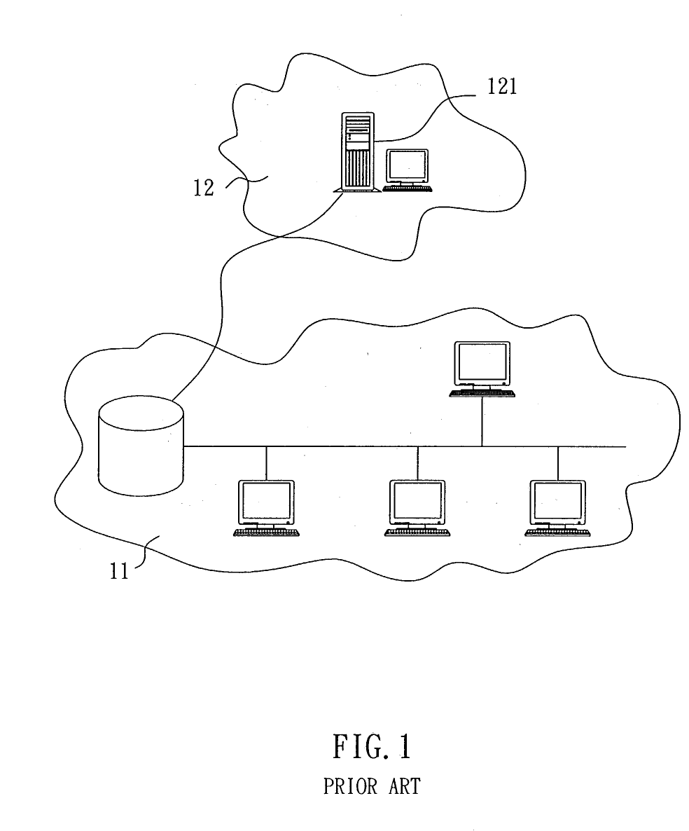

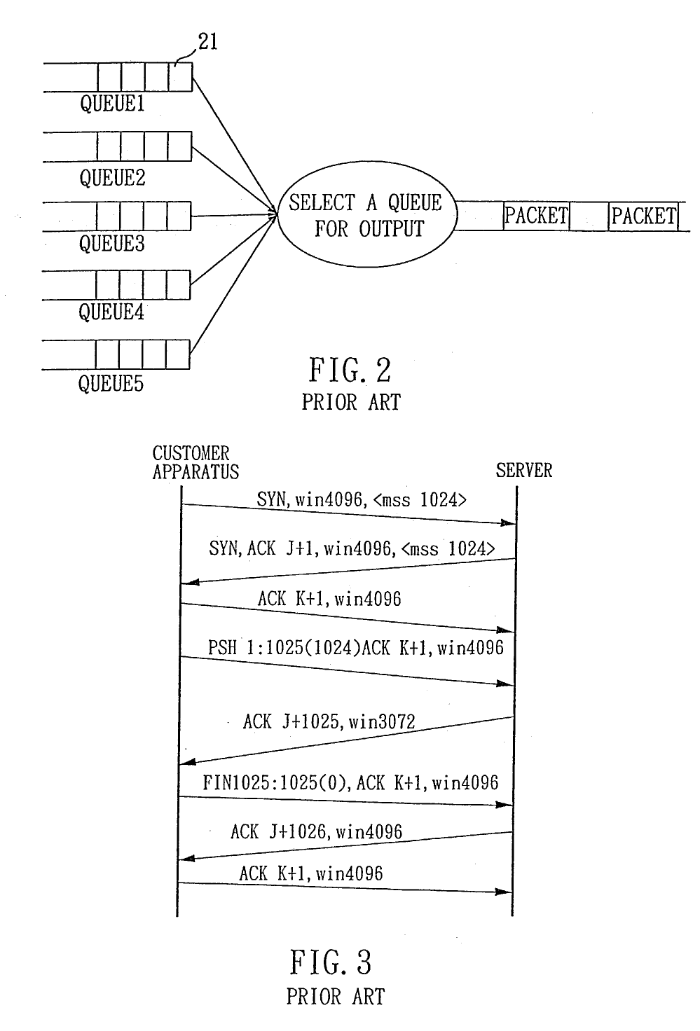

### DETAILED DESCRIPTION OF THE PREFERRED EMBODIMENT

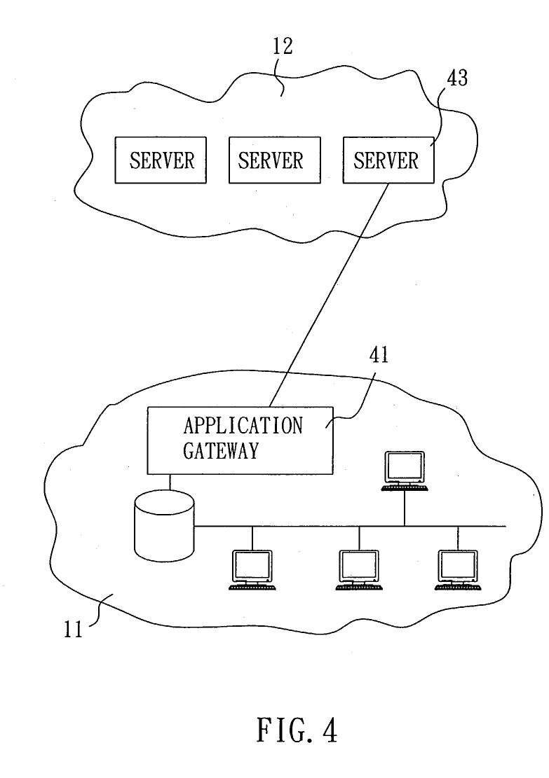

FIG. 4 illustrates the network flow controlling system in accordance with a preferred embodiment of the present invention. As shown, an application gateway 41 is installed in the customer side 11. All packets transmitted between the server 43 and users in customer side 11 will pass through the application gateway 41, thereby the application gateway 41 performs bandwidth management on the link between the customer side 11 and the service provider side 12.

When internal users use network application program connecting to the server 43, one or more than one TCP connections can be used to get the contents from the server 43. The present invention defines a session of a network application program as all TCP or UDP connections in a period that a network application program is getting contents from a server 43 (for example, browsing a website by HTTP, or getting a file from a server by FTP). A session begins at the first TCP or UDP connection establishment, and ends at the last TCP or UDP connection termination. For example, in the HTTP session of FIG6, the user of the customer side 11 clicks a webpage, the browser builds a TCP connection with the server 43 and downloads the index.html. Then the browser downloads the files described in index.html from the server 43 through the original TCP connections or newly reestablished TCP connections. The FTP session of FIG. 7 builds a control TCP connection at first, and establishes a new TCP connection for transferring data after receiving the get or put files commands from the control connection.

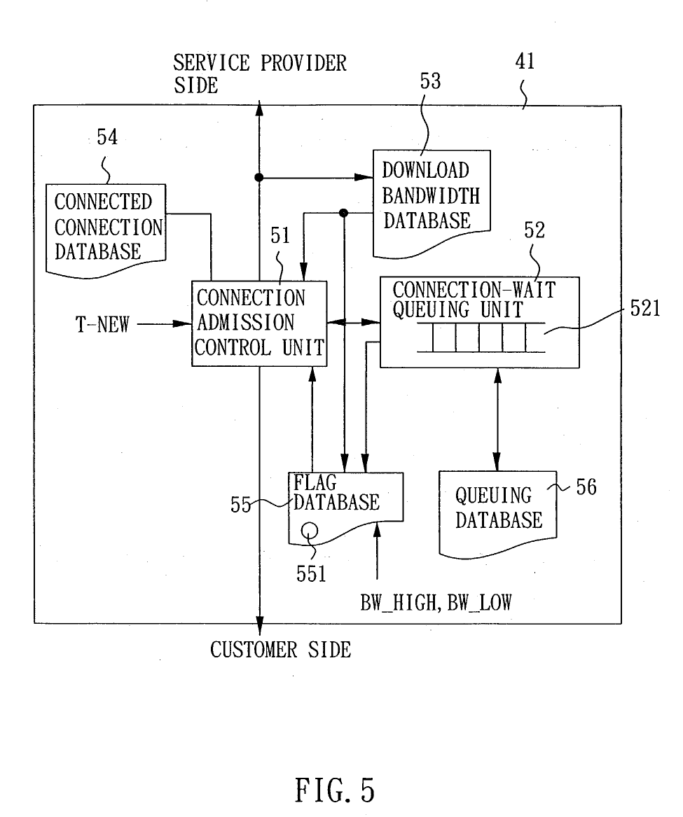

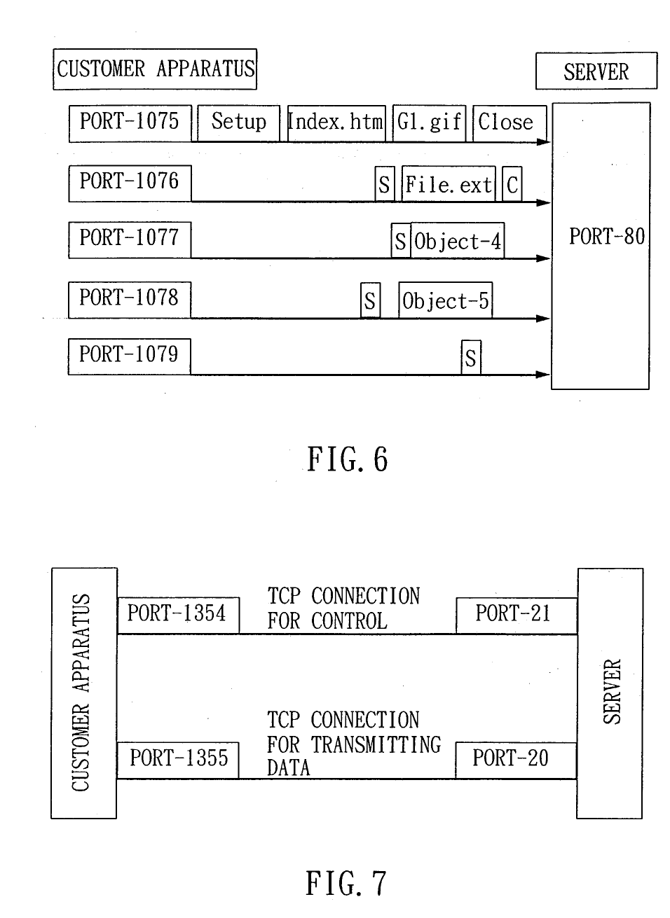

FIG. 5 shows the structure of the application gateway 41, which has a connection admission control unit 51 and a connection-wait queuing unit 52.The connection-wait queuing unit 52 has a main queue 521.The connection admission control unit 51 investigates all packets sent to the service provider side, and allows connection setup packets to be sent out or redirects connection setup packets to the connection-wait queuing unit 52 based on the FLAG database. The connection-wait queuing unit 52 queues the connection setup packets, and responses appropriate packets to keep the network application connection status and give the queuing status to the users. The connection-wait queuing unit 52 allows packets in the queue to be sent out, when the download bandwidth utilization becomes available.

The application gateway 41 also has a download bandwidth database 53, a connected connection database 54, a flag database 55, and a queuing database 56. The download bandwidth database 53 records the download bandwidth used by each established connection and the download bandwidth utilization in the link between the customer side 11 and the service provider side 12.The connected connection database 54 records information about sessions admitted by the connection admission control unit 51, which comprises IP address, TCP/UDP connections, number of TCP/UDP connections of each session, and the time that the latest packet passed. The queuing database 56 records IP addresses, TCP/UDP ports, types of network application programs, and the queuing information of the network application sessions queued in the connection-wait queuing unit 52.The flag database 55 maintains at least one main flag 551, and the main flag 551 statuses depends on the download bandwidth utilization and the queue status. The connection admission control unit 51 allows establishing new sessions when the main flag is set, and disallows establishing new sessions when the main flag is clear.

The application gateway 41 further defines a high bandwidth (BW_HIGH) threshold and a low bandwidth (BW_LOW) threshold. The main flag changes the set state to the clear state, when the download bandwidth utilization becomes larger than BW_HIGH threshold. The main flag 51 changes the clear state back to the set state, when the download bandwidth utilization becomes smaller than BW_LOW threshold and the main queue 51 is empty.

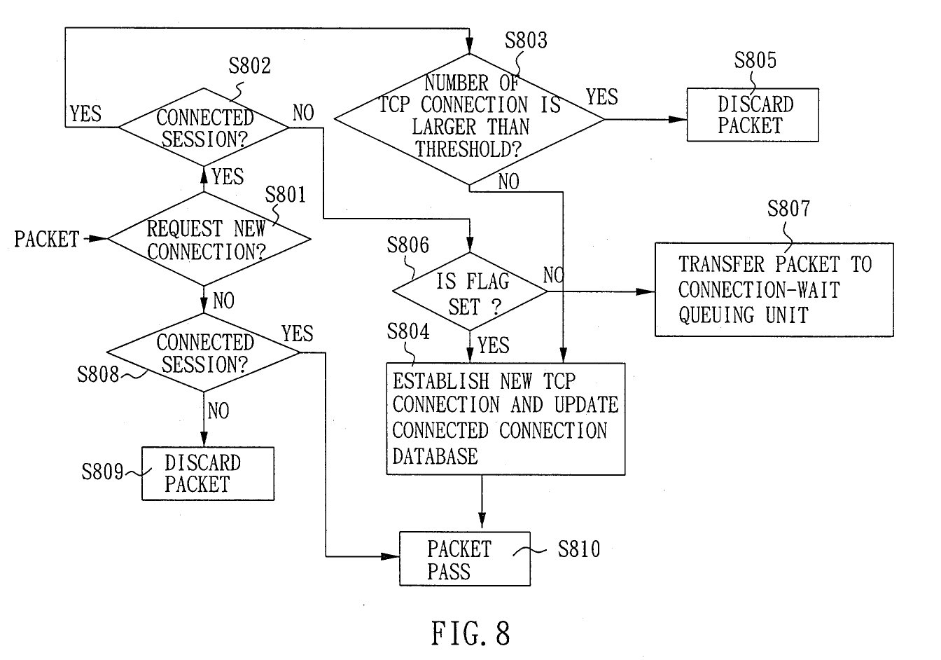

FIG. 8 illustrates a flow chart for transferring packets by the present system. When a packet enters into an application gateway 41, step S801 checks whether the packet requests a new TCP connection (for example, a SYN packet of TCP). If yes, step S802 compares the IP addresses and TCP ports of the packet with the connected connection database 54 to determine whether this new TCP connection belongs to a connected session. If same IP addresses and TCP ports are found, the packet belongs to a connected session. Step S803 counts the number of TCP connections of the connected session. If the number of TCP connections is smaller than a predetermined threshold, this new connection is allowed, and the connected connection database 54 is updated (step S804), and allows the packet to pass (step S810). If the number of TCP connections is larger than the threshold, step S803 drops the packet directly to prevent the user form using a special network software to transfer data massively by using multiple TCP connections at the same time.

If step S802 determines that the TCP connections is not belonged to a connected session, the TCP connection is used as a first TCP connection in a new network application session, and step S806 checks the main flag 551 status of the flag database 55. If the flag is set, the application gateway 41 allows the TCP connection establishment, updates the connected connection database (step S804), records data related to the network application session, and allows the packet to pass (step S810). On the contrary, if the flag is cleared, the application gateway 41 transfers the packet to the connection-wait queuing unit 52.

If step S801 determines that the packet doesn't request a new TCP connection establishment, the application gateway 41 checks whether the packet belongs to a connected session (step S808). If yes, the packet is passed (step S810); otherwise, the packet is discarded (step S809).

In above step S807, the connection-wait queuing unit 52 queues the connection setup packet of the network application which is suitable for queuing, and discards the connection setup packet of the network application which is not suitable for queuing. The connection-wait queuing unit 52 responses a corresponding TCP packet to keep the user's network application in a connections success status after queuing the connection setup packet. When the connection-wait queuing unit 52 determines that the network application connection can be established, the connection-wait queuing unit 52 automatically redirects the network application to the server user originally intends to. In case of HTTP, to achieve aforementioned object, the connection-wait queuing unit 52 transmits a virtual webpage containing the TCP queuing information, so that the user can know the queuing status and the network condition. Furthermore, the content of<META HTTP-EQUIV=refresh CONTENT=“refresh time”> is added to make the browser of the internal user periodically refresh the virtual page from the connection-wait queuing unit 52, thereby updating the waiting information.

The connection-wait queuing unit 52 determines whether a TCP connection waiting in the main queue 521 can connect to an external server based on the download bandwidth and BW_LOW. The connection-wait queuing unit 52 does not allow the TCP connection connecting to the external server in the situation that the download bandwidth utilization is larger than BW_LOW. When the download bandwidth utilization is smaller than BW_LOW, the connection-wait queuing unit 52 allows the first TCP connection in the main queue 521 connecting to the external server in every period of time T_NEW.

After admitting a TCP connection establishment, the connection-wait queuing unit 52 can fetch all the content from the server in a proxy manner and responds the original webpage content to the internal user at the next refresh time. Alternatively, the connection-wait queuing unit 52 responds a virtual webpage containing related redirect information (for example, ASP syntax:<% Response. Redirect “http://www.kimo.com.tw”%> will redirect the browser to www.kimo.com.tw) to the user's browser at the next refresh time. As a result, the user's browser will be redirected to an actual server to browse the actual webpage. Then, the connection-wait queuing unit 52 removes the information about the TCP connection from the main queue 521 and records the related information of the TCP connection to the connected connection database 54.

With the above operation, the bandwidth control system can prevent that too many users share the download bandwidth in the same time via reasonably setting the BW_HIGH and BW_LOW. Therefore, the connected network application sessions have more stable bandwidth and the retransmitting probability is reduced. Moreover, the rejected network application session can be queued in the main queue 521 until download bandwidth becomes available and the intended contents will be automatically obtained.

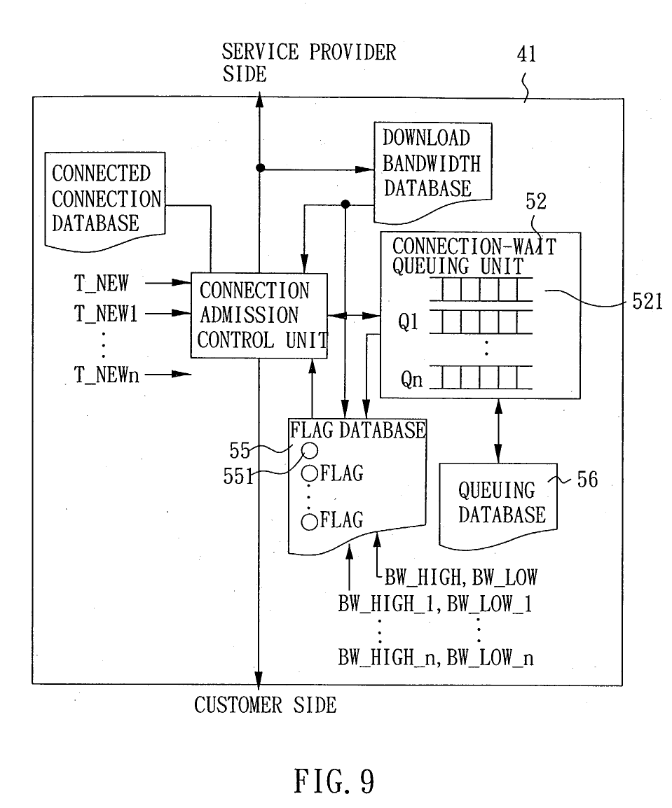

FIG. 9 shows an application gateway in the bandwidth control system in accordance with another preferred embodiment of the present intention. This embodiment is different from the previous one in that, in addition to the main queue 521, the connection-wait queuing unit 52 further has a plurality of extending queues Q# (# represents a serial number of an extending queue), and in addition to the main flag 551, the flag database 55 further has a plurality of extending flags FLAG_#. Each extending queue Q# represents a policy, which can be a combination of a network application, an external server, a group of external servers, and a group of internal users. The application gateway defines corresponding BW_HIGH_#, BW_LOW#, FLAG_#, and T_NEW_# for each extending Q#. The n-th extending flag FLAG_n changes set state to clear state in the condition that the download bandwidth utilization of the policy becomes larger than BW_HIGH_n, and changes clear state to set state in the condition that the download bandwidth utilization becomes lower than BW_LOW_# and the extending queue Qn is empty. When the application gateway receives a packet which requests a new session establishment, the admission control unit 51 first compares the packet data with policy data to find out the corresponding queue Qn and checks the extending flag FLAG_n. If FLAG_n is in clear state, the admission control unit 51 transfers this packet to the connection-wait queuing unit 52 and the connection-wait queuing unit 52 places the packet in the extending queue Qn. If FLAG_n is in set state, the admission control unit 51 further checks the main flag 551 .If the main flag is in clear state, the admission control unit 51 transfers this packet to the connection-wait queuing unit 52 and the connection-wait unit 52 places the packet in the main queue 521. If the main flag is in set state, the admission control unit 51 allows the packet sending to the external server and update connected connection database 54. In the connection-wait queuing unit 52, the operation of the main queue 521 is identical to that of the previous embodiment. For the n-th extending queue Qn, if the download bandwidth utilization of a corresponding policy is smaller than BW_LOW_n, the first connection in the Qn is moved to the main queue 521 for every time interval T_NEW_n.

In this embodiment, two layers of queues, the main queue and the policy queues, are used as an example. However, in a practical application, the queues can be designed to have more than two layers.

With the above multiple queues, the present invention can be used to mange the bandwidth of respective server and respective user, so that the server or the user will not occupy too much bandwidth and affect others.

Although the present invention has been explained in relation to its preferred embodiment, it is to be understood that many other possible modifications and variations can be mad without departing from the spirit and scope of the invention as hereinafter claimed.

What is claimed is:

1. A system for controlling network flow by monitoring download bandwidth utilization comprising:
a service provider side having at least one server for providing network service;
a customer side capable of requesting to establish a new session to the server via a link; and
an application gateway arranged in the customer side for providing network management on a link between the customer side and the service provider side, the application gateway including:
a connection-wait queuing unit having main queue; and
a connection admission control unit for discarding or transferring a packet requesting a new session establishment to the main queue when a download bandwidth utilization in the link is larger than a predetermined bandwidth threshold, and allowing the packet requesting a new session establishment to pass when the download bandwidth utilization is smaller than a predetermined bandwidth threshold and no session is in the main queue.

2. The system for controlling network flow by monitoring download bandwidth utilization as claimed in claim 1, wherein the session includes a plurality of connections established.

3. The system for controlling network flow by monitoring download bandwidth as claimed in claim 1, wherein when the download bandwidth utilization is lager than a predetermined bandwidth, the connection-wait queuing unit does not permit a connection in the main queue to be connected to the server, and when the download bandwidth is smaller than the predetermined bandwidth, it permits the first connection in the main queue to be connected to the server for every time interval.

4. The system for controlling network flow by monitoring download bandwidth utilization as claimed in claim 1, wherein the connection-wait queuing unit queues the sessions requesting for connections and displays queuing information to the customer side.

5. The system for controlling network flow by monitoring download bandwidth utilization as claimed in claim 4, wherein a waiting time status is displayed.

6. The system for controlling network flow by monitoring download bandwidth utilization as claimed in claim 3, wherein when the connection-wait queuing allows the session establishment, the content of desired server is automatically downloaded to the corresponding network application program.

7. The system for controlling network flow by monitoring download bandwidth utilization as claimed in claim 1, wherein the application gateway further has a flag database for providing at least one main flag; when the download bandwidth is lower than a predetermined low bandwidth and the main queue does not have a session in waiting, the main flag in clear state will change to set state to represent that a new session is allowed to established; when the download bandwidth is larger than a predetermined high bandwidth, the main flag in set state will change to clear state to represent that a new session is not allowed to establish.

8. The system for controlling network flow by monitoring download bandwidth utilization as claimed in claim 1, wherein the application gateway further has a download bandwidth database for recording the download bandwidth utilization in the link between the managed customer side and service provider side.

9. The system for controlling network flow by monitoring download bandwidth utilization as claimed in claim 1, wherein the application gateway further has a connected connection database for recording information related to the network application sessions allowed to be established by the connection admission control unit.

10. The system for controlling network flow by monitoring download bandwidth utilization as claimed in claim 1, wherein the application gateway further has a queuing database for recording information related to the network application sessions waiting in the connection-wait queuing unit.

11. The system for controlling network flow by monitoring download bandwidth utilization as claimed in claim 7, wherein the flag database further has a plurality of extending queues, and the connection-wait queuing unit further has a plurality of extending high queues, each representing a policy and corresponding to an extending high bandwidth, an extending low bandwidth, an extending flag, and an extending time interval; when the download bandwidth utilization of a policy is lager than a corresponding high bandwidth, the corresponding extending flag in set state is cleared; when an extending queue has no connection in waiting and the download bandwidth utilization of the corresponding policy is smaller than the corresponding extending low bandwidth, the corresponding extending flag in clear state is set.

12. The system for controlling network flow by monitoring download bandwidth as claim 11, wherein when one extending flag is in clear state, if there is a corresponding new session to be established, the session is transferred to a corresponding extending queue in the connection-wait queuing unit.

13. The system for controlling network flow by monitoring download bandwidth utilization as claimed in claim 11, wherein when one extending flag is in set state, if there is a corresponding new session to be established, the flag of the main queue is checked, and if it is in clear state, the session is transferred to the main queue of the connection-wait queuing unit; otherwise, the session is allowed to be established.

14. The system for controlling network flow by monitoring download bandwidth utilization as claimed in claim 11, wherein when the download bandwidth utilization of a policy is smaller than a corresponding extending low bandwidth, the session in the corresponding extending queue is transferred to the main queue for every corresponding extending time interval.

15. The system for controlling network flow by monitoring download bandwidth utilization as claimed in claim 2, wherein the link period is a HTTP session having a plurality of TCP connections.

16. The system for controlling network flow by monitoring download bandwidth utilization as claimed in claim 2, wherein the session is a FTP session having a TCP connection for controlling, and at least one TCP connection for transferring data.
